(19) United States
(12) Patent Application Publication
(10) Pub. No.: US 2014/0347360 A1
(43) Pub. Date: Nov. 27, 2014

(54) METHOD AND APPARATUS FOR MULTI DIMENSIONAL VISUALIZATION OF DATA USING 3-DIMENSIONAL LIGHT EMITTING APPARATUS

(71) Applicant: Electronics and Telecommunications Research Institute, Daejeon (KR)

(72) Inventors: Jae Ho LIM, Daejeon (KR); Hyo Bong Hong, Daejeon (KR); Sung Woong Shin, Daejeon (KR); Jong-Hyun Park, Daejeon (KR)

(73) Assignee: Electronics and Telecommunications Research Institute, Daejeon (KR)

(21) Appl. No.: 14/149,002

(22) Filed: Jan. 7, 2014

(30) Foreign Application Priority Data
May 22, 2013 (KR) 10-2013-0057893

(51) Int. Cl. G06T 15/50

(52) U.S. Cl. CPC G06T 15/50
USPC 345/426

(57) ABSTRACT

A method for multi-dimensional visualization of data performed in a data display apparatus, includes: collecting data obtained by scanning at least one part of a sample, from at least one sensor; and comparing a resolution of 3-dimensional light emitting apparatus and a resolution of the scanned data. Further, the method includes adjusting the resolution of the scanned data to be matched with the resolution of the 3-dimensional light emitting apparatus, when the resolution of 3-dimensional light emitting apparatus is not identical to the resolution of the scanned data; and displaying the data corresponding to the sample in the adjusted resolution by driving the 3-dimensional light emitting apparatus.

### CROSS-REFERENCE TO RELATED APPLICATION(S)

The present invention claims priority of Korean Patent Application No. 10-2013-0057893, filed on May 22, 2013, which is incorporated herein by reference.

### FIELD OF THE INVENTION

The present invention relates to a method and apparatus for multi-dimension visualizing data using 3-dimensional emitting apparatus, and, more specifically, to a method and apparatus for visualization of data sensed from heterogeneous sensors.

### BACKGROUND OF THE INVENTION

With the development of engineering technology, the trend is that 3-dimensional interface technology to provide realistic information based on text, sound and image is under active development. Further, the 3-dimensional interface is classified as a technology that can play an important role to create new media and to make user interface realistic.

In this case, the method for visualizing and displaying data is achieved by analyzing data and displaying the data on a 2-dimensional monitor. Regarding the method for visualizing and displaying data, a related art Korean Laid-Open Patent publication No. 2011-0092589, which is laid opened on Aug. 18, 2011, discloses a configuration in which classified items and time series items are extracted by analyzing data, concentric circles are formed depending on the number of the time series items and the concentric circles divided depending on the number of the classified items are displayed.

However, when providing the method to visualize and display data, the related art merely discloses a configuration in which 3-dimensional data are displayed on the 2-dimensional plane.

### SUMMARY OF THE INVENTION

In view of the above, the present invention provides a method and apparatus for multi-dimensional visualization of data using a 3-dimensional light emitting apparatus that are capable of expressing heterogeneous physical data using a multilayer LED structure. However, the technical subjects of the present invention are not limited to the foregoing subjects, and there may be other technical subjects.

In accordance with a first aspect of the present invention, there is provided a method for multi-dimensional visualization of data performed in a data display apparatus. Further, the method includes collecting data obtained by scanning at least one part of a sample, from at least one sensor; comparing a resolution of 3-dimensional light emitting apparatus and a resolution of the scanned data; adjusting the resolution of the scanned data to be matched with the resolution of the 3-dimensional light emitting apparatus, when the resolution of 3-dimensional light emitting apparatus is not identical to the resolution of the scanned data; and displaying the data corresponding to the sample in the adjusted resolution by driving the 3-dimensional light emitting apparatus.

Further, the sensor may comprise at least one of a pressure sensor, temperature sensor, friction sensor, photo sensor, magnetic sensor, acceleration sensor, angular velocity sensor, revolution sensor, infrared sensor, ultrasonic sensor, humidity sensor, touch sensor, gradient sensor, load sensor, vibration sensor, gravity sensor, gas sensor, proximity sensor, displacement sensor, hall sensor and piezoelectric sensor, and may be substituted with a camera.

Further, the scanned data may be 1-dimensional arrangement data; and the 1-dimensional arrangement data may be combined with a reversed pattern of the sample that is scanned so that the 1-dimensional arrangement data are converted into 2-dimensional arrangement data.

Further, the scanned data may be 2-dimensional arrangement data; and the 2-dimensional arrangement data may be projected on a part basis to extract overlapped areas and are converted into 3-dimensional arrangement data based on the extracted area.

Further, the scanned data may be data obtained by sampling on a part basis.

Further, the 3-dimensional light emitting apparatus may comprise at least one light emitting device formed in 3-dimension; and the at least one light emitting device may be arranged in array.

Further, the 3-dimensional light emitting apparatus may comprise at least one light emitting device formed in 3-dimension; and the scanned data may be displayed in the 3-dimensional light emitting apparatus based on at least one of position, light-on, light-off, color, brightness, and light-on/off period of the at least one light emitting device.

Further, the 3-dimensional light emitting apparatus may comprise at least one light emitting device formed in 3-dimension; and the at least one light emitting device may be arranged in a cube shape.

Further, the scanned data may be based on physical data for at least one part of the sample.

In accordance with a second aspect of the present invention, there is provided a data display apparatus. The data display apparatus includes a collection unit configured to collect data obtained by scanning at least one part of a sample, from at least one sensor; a comparison unit configured to compare a resolution of 3-dimensional light emitting apparatus and a resolution of the scanned data; an adjustment unit configured to adjust the resolution of the scanned data to be matched with the resolution of the 3-dimensional light emitting apparatus, when the resolution of 3-dimensional light emitting apparatus is not identical to the resolution of the scanned data; and an output unit configured to display the data corresponding to the sample in the adjusted resolution by driving the 3-dimensional light emitting apparatus.

Further, the scanned data may be 1-dimensional arrangement data; and the collection unit may be configured to combine the 1-dimensional arrangement data with a reversed pattern of the sample that is scanned so that the 1-dimensional arrangement data are converted into 2-dimensional arrangement data.

Further, the scanned data may be 2-dimensional arrangement data, and the collection unit may be configured to project the 2-dimensional arrangement data for a part to extract overlapped areas and convert it into 3-dimensional arrangement data based on the extracted area.

In accordance with any one of solutions to the subject described above, there may be provided an original technology needed to develop a high-dimensional interface.

### BRIEF DESCRIPTION OF THE DRAWINGS

The above and other objects and features of the present invention will become apparent from the following description of embodiments given in conjunction with the accompanying drawings, in which:

FIG. 1 is a schematic block diagram of an apparatus for multi-dimensional visualization of data using a 3-dimensional light emitting apparatus in accordance with the present invention;

FIG. 2 is a configuration diagram illustrating an apparatus for multi-dimensional visualization of data shown in FIG. 1;

FIG. 3A and FIG. 3B show views of an embodiment and another embodiment of an apparatus for multi-dimensional visualization of data shown in FIG. 1, respectively;

FIG. 4 is a configuration diagram of a system for multi-dimensional visualization of data using a 3-dimensional light emitting apparatus shown in FIG. 1; and

FIG. 5 is a flowchart illustrating a method for multi-dimensional visualization of data using a 3-dimensional light emitting apparatus in accordance with an embodiment of the present invention.

### DETAILED DESCRIPTION OF THE EMBODIMENTS

Hereinafter, embodiments of the present invention will be described in detail with reference to the accompanying drawings which form a part hereof.

Throughout the specification and the claims, when an element is described as being “connected” to another element, this implies that the elements may be directly connected together or the elements may be connected through one or more intervening elements. Furthermore, when an element is described as “including” one or more elements, this does not exclude additional, unspecified elements, nor does it preclude the presence or addition of one or more other features, integers, steps, operations, elements, components and/or groups thereof.

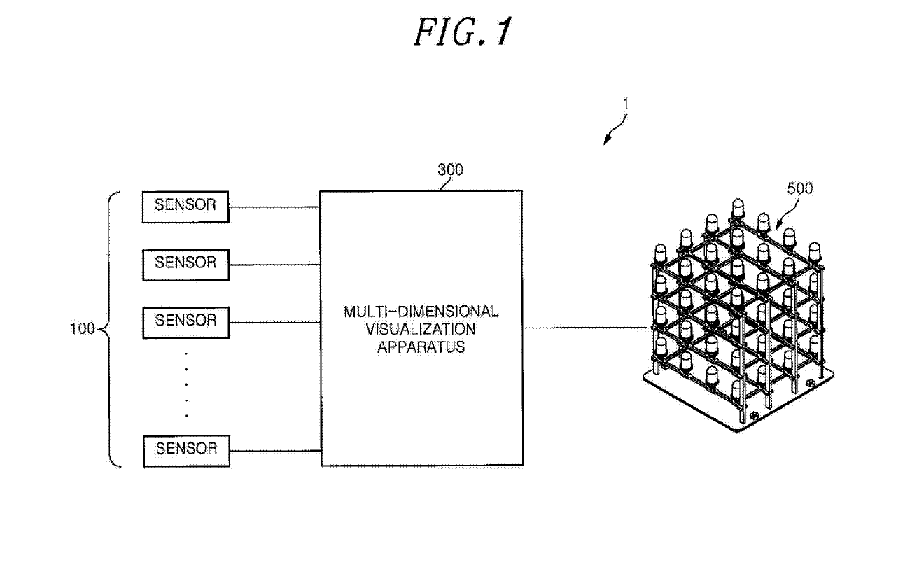

FIG. 1 is a schematic block diagram of an apparatus for multi-dimensional visualization of data using a 3-dimensional light emitting apparatus in accordance with the present invention. Referring to FIG. 1, a system 1 for multi-dimensional visualization of data using a 3-dimensional light emitting apparatus in accordance with an embodiment of the present invention comprises at least one sensor 100, an apparatus for multi-dimensional visualization of data 300, and a 3-dimensional light emitting apparatus 500. However, such a system 1 for multi-dimensional visualization of data using a 3-dimensional light emitting apparatus shown in FIG. 1 is merely an embodiment of the present invention, and the present invention is not construed to be limited to FIG. 1.

The sensor 100 may be a sensor to monitor a sample. In this case, the sample may have different types of data values at same points, and the sensor 100 may sense the different types of data values of the sample. In this case, the sensor 100 may be at least one of a pressure sensor, temperature sensor, friction sensor, photo sensor, magnetic sensor, acceleration sensor, angular velocity sensor, revolution sensor, infrared sensor, ultrasonic sensor, humidity sensor, touch sensor, gradient sensor, load sensor, vibration sensor, gravity sensor, gas sensor, proximity sensor, displacement sensor, hall sensor, piezoelectric sensor, and others. Further, the sensor 100 may sense at least one portion of the sample, and the sensor 100 may be substituted with a camera.

The apparatus 300 for multi-dimensional visualization of data may be an apparatus to control the 3-dimensional light emitting apparatus 500. Further, the apparatus 300 may express heterogeneous physical data in 3-dimension using a multi-layered LED structure. Further, the apparatus 300 may embody a technology of calculating and adjusting the difference of resolution occurred between the sensor 100 and the 3-dimensional light emitting apparatus 500 and may enable the 3-dimensional light emitting apparatus 500 that may be a multi-dimensional LED structure to display the processed signal.

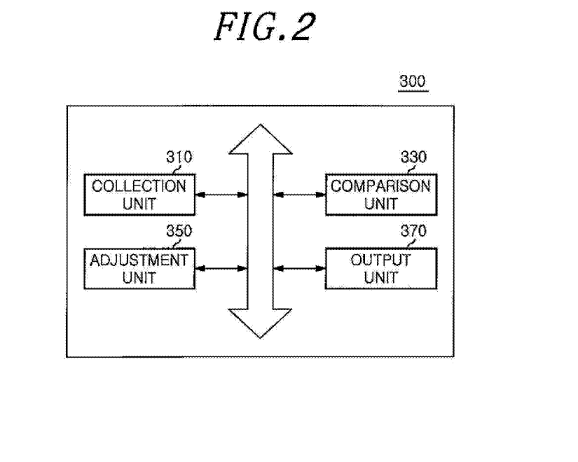

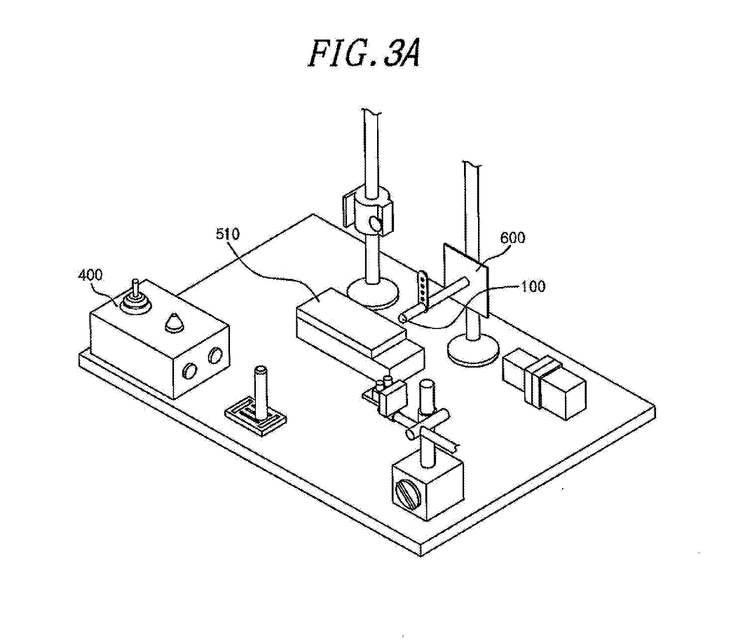

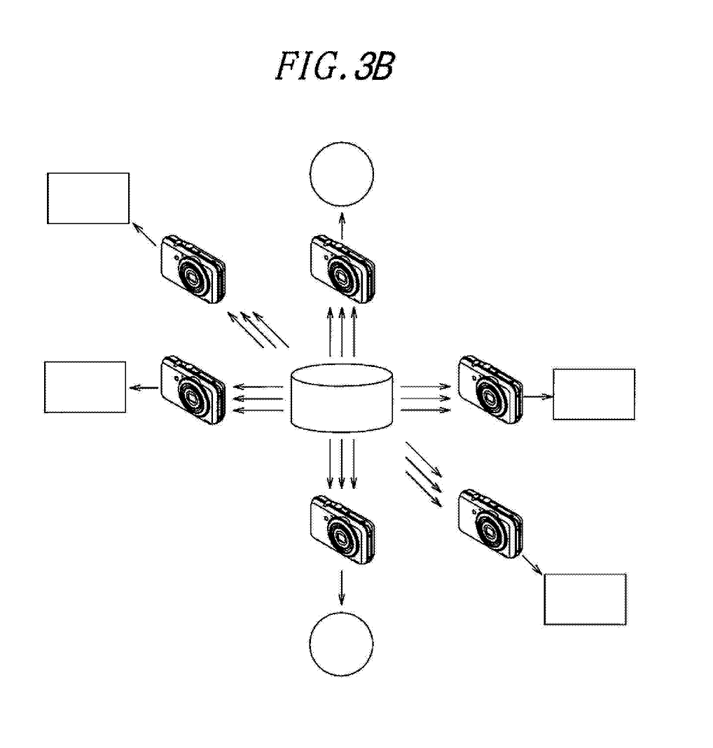

FIG. 2 is a configuration diagram illustrating an apparatus for multi-dimensional visualization of data shown in FIG. 1, and FIG. 3A and FIG. 3B show views of an embodiment and another embodiment of an apparatus for multi-dimensional visualization of data shown in FIG. 1, respectively.

Referring to FIG. 2, the apparatus 300 for multi-dimensional visualization of data may comprise a collection unit 310, a comparison unit 330, a control unit 350, and an output unit 370.

The collection unit 310 collects data obtained by scanning at least one part of a sample, from the sensor 100. In this case, the sample may have the different types of data at same points. For example, in case that the sample is a rabbit's tail, the sensor 100 may sense temperature and roughness of the rabbit's tail. Further, the sensor 100 may comprise at least one of a pressure sensor, temperature sensor, friction sensor, photo sensor, magnetic sensor, acceleration sensor, angular velocity sensor, revolution sensor, infrared sensor, ultrasonic sensor, humidity sensor, touch sensor, gradient sensor, load sensor, vibration sensor, gravity sensor, gas sensor, proximity sensor, displacement sensor, hall sensor and piezoelectric sensor, and the sensor 100 may be substituted with a camera. Further, the scanned data may be data that are sampled for at least one part of the sample or may be data based on physical data of at least one part of the sample.

The former case for the sensor 100 will be described with reference to FIG. 3A and the latter case for the sensor 100 will be described with reference to FIG. 3B.

On describing the former case with reference to FIG. 3A, a sample 510 is put on an XY stage, and the sample 510 is scanned in a predetermined pattern using the sensor 100. Here, the system 1 for multi-dimensional visualization of data using a 3-dimensional light emitting apparatus further comprises a sensor holder 600 holding the sensor 100 and a stage controller 400 that can move the XY stage along XY axes. In this case, the stage controller 400 may be a manual controller and an automatic controller. Accordingly, the collection unit 310 may secure the scanned data in 1-dimensional arrangement using the sensor 100. Therefore, the scanned data from the sensor 100 may be 1-dimensional arrangement data, and the collection unit 310 may convert the 1-dimensional arrangement data into a 2-dimensional arrangement data by combining the 1-dimensional arrangement data with its reversed pattern of the sample that is scanned in reverse.

On describing the latter case with reference to FIG. 3B, it may be possible to obtain values in 2-dimensional arrangement by taking a picture of the sample using a camera in different directions. Therefore, the collection unit 310 may secure the scanned data in 2-dimensional arrangement using the sensor 100 when the sensor 100 is a camera. Accordingly, the scanned data from the sensor 100 may be 2-dimensional arrangement data, and the collection unit 310 may project the 2-dimensional arrangement data on a part basis, extract an overlapped area, and convert the 2-dimensional arrangement data into 3-dimensional arrangement data based on the extracted area.

Referring to FIG. 2 again, the comparison unit 330 compares the resolution of the 3-dimensional light emitting apparatus 500 with that of the scanned data. For example, since the resolution of the data that is scanned and the resolution of the 3-dimensional light emitting apparatus 500 to display the data may not be identical to each other, the comparison unit 330 compares both resolutions in order to match both data.

The adjustment unit 350 adjusts the resolution of the scanned data to be matched with that of the 3-dimensional light emitting apparatus 500, when the resolution of the 3-dimensional light emitting apparatus 500 is not identical to that of the scanned data as a result of the comparison in the comparison unit 330. For example, it is assumed that the scanned data has a resolution of 800 and the 3-dimensional light emitting apparatus 500 exhibits a resolution of 80. In this case, since the resolution of the scanned data should be reduced to one to ten (80/800), the adjustment unit 350 may use one of ten scanned data, or convert ten data into one representative value using an averaging method to use it. Otherwise, it is assumed that the resolution of the scanned data is 80 and the resolution of 3-dimensional light emitting apparatus 500 is 800. In this case, the resolution of the scanned data should be increased 10 times (800/80), the adjustment unit 350 may use 10 data that are duplicated from one scanned data, or may interpolate the resolution using the linear interpolation.

The output unit 370 displays the data corresponding to the sample in an adjusted resolution by driving the 3-dimensional light emitting apparatus 500. In this case, the 3-dimensional light emitting apparatus 500 may comprise at least one light emitting device formed in 3-dimension, and the at least one light emitting device may be arranged in array. Further, the 3-dimensional light emitting apparatus 500 may comprise at least one light emitting device formed in 3-dimension, and the at least one light emitting device may be arranged in a cube shape. Here, the 3-dimensional light emitting apparatus 500 is defined as a concept to include 1-dimension or 2-dimension although it is described in 3-dimension. Further, the scanned data may be displayed in the 3-dimensional light emitting apparatus 500, based on at least one of position, light-on, light-off, color, brightness, and light-on/off period of the at least one light emitting device. For example, the color of an image may be expressed using RGB values; intensity may be expressed using the brightness; and a frequency or period may be used using a flickering. Further, a 3-dimensional real object may be displayed in its own volume in a 3-dimensional structure of the 3-dimensional light emitting apparatus 500, thereby recognizing the shape of the real object in a variety of time points at same time.

The system for multi-dimensional visualization of data using 3-dimensional light emitting apparatus in accordance with the present invention may effectively express heterogeneous sensing data that are not easy to express, using a multi-layer LED structure as a display. Further, it may be possible to express physical data having no reality with feasibility. Further, it may be possible to easily express a position in a 3-dimensional space and physical information that are not easy to express with a general display.

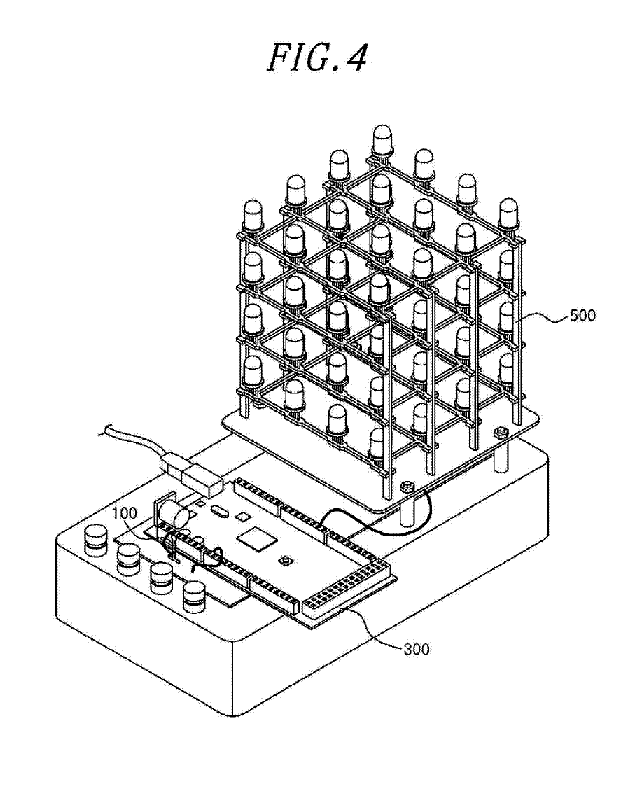

FIG. 4 is a configuration diagram of a system for multi-dimensional visualization of data using a 3-dimensional light emitting apparatus shown in FIG. 1. Referring to FIG. 4, it illustrates an embodiment in which a system 1 for multi-dimensional visualization of data using a 3-dimensional light emitting apparatus shown in FIG. 1 is implemented.

Referring to FIG. 4, a following construction is required as preparation material for an experiment.

First, as an object to be measured, there is prepared a sample which has a variety of data values at same point, such as roughness, temperature, etc. Further, at least one sensor 100 is prepared such as a pressure sensor and a temperature sensor that may measure a variety of data values. Further, as the apparatus 300 for multi-dimensional visualization of data, there is prepared a system for transmitting or processing measured data such as an Arduino board; and as the 3-dimensional light emitting apparatus 500, there is prepared a 3-dimensional RGB LED structure in a cube shape to display all kinds of data such as an LED cube.

An experiment example using the construction described above will be described below.

First, there are prepared a pressure sensor and a temperature sensor as the sensor 100, and a periodic sampling is performed for each part of the sample while entirely scanning the relevant sample using the pressure sensor and temperature sensor. Further, when tactile data and temperature data are obtained, the apparatus 300 adjusts resolution in harmony with the number of LED in each axis consisting XYZ axes of an LED structure that is the 3-dimensional light emitting apparatus 500. In this experiment example, ATmega2560 chip is used as hardware to obtain data values and adjust the resolution.

Further, the tactile data are expressed as the position of Z value on a relevant X-Y point in the LED structure, and the temperature data may be displayed as RGB color combination of the LED. In this case, an algorithm for multi-dimensional visualization of data is programmed in an ATmega2560 chip. Additionally, in another embodiment, more types of data may be expressed using brightness and flickering of the LED.

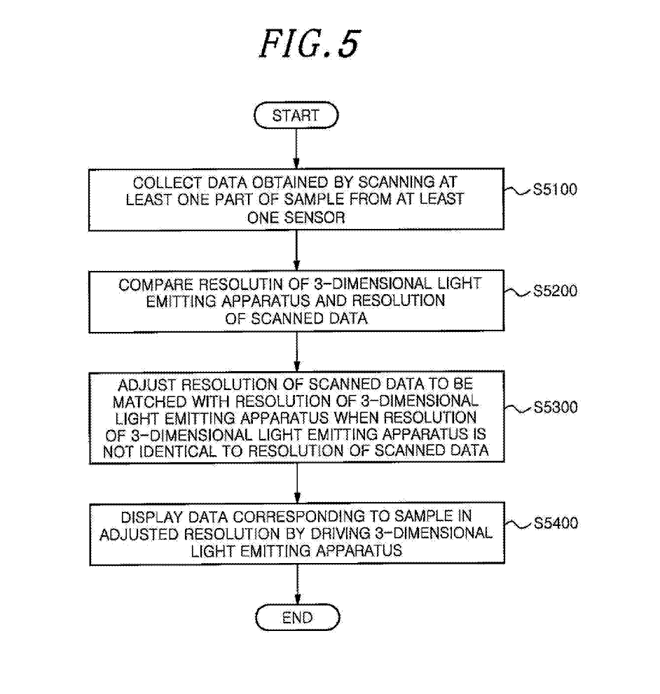

FIG. 5 is a flowchart illustrating a method for multi-dimensional visualization of data using 3-dimensional light emitting apparatus in accordance with an embodiment of the present invention.

First, the apparatus for multi-dimensional visualization of data collects data obtained by scanning at least one part of a sample, from the sensor, in block S5100.

Next, the apparatus for multi-dimensional visualization of data compares the resolution of the 3-dimensional light emitting apparatus and that of the scanned data, in block S5200.

At this time, the apparatus for multi-dimensional visualization of data adjusts the resolution of the scanned data to be matched with that of the 3-dimensional light emitting apparatus, in block S5300.

Finally, the data corresponding to the sample is displayed in the adjusted resolution by driving the 3-dimensional light emitting apparatus, in block S5400.

The order of the above operations described in blocks S5100 to S5400 is merely an example, and not limited thereto. That is, the order of the operations described in blocks S5100 to S5400 may be mutually exchanged, and some of these operations may be simultaneously executed or removed.

Matters that are described for the method for multi-dimensional visualization of data using a 3-dimensional light emitting apparatus shown in FIG. 5 are omitted below, since they are identical to the description for multi-dimensional visualization of data using a 3-dimensional light emitting apparatus through FIGS. 1 to 4 or may be easily inferred from the above description.

The method for multi-dimensional visualization of data using a 3-dimensional light emitting apparatus of the embodiment described in FIG. 5 may be implemented in the form of recording media including instructions executable by a computer, such as applications or program modules that are executed by a computer. The computer readable media may be any available media that can be accessed by a computer and may include volatile and nonvolatile media, and removable and non-removable media. Further, the computer readable media may include any computer storage media and communication media. The computer storage media may include any volatile and nonvolatile media and removable and non-removable storage media that are implemented in any methods or technologies for the storage of information such as data and computer-readable instructions, data structures, program modules, or other data. The communication media may include a transport mechanism or any information delivery media for transmitting computer readable instructions, data structures, program modules or other data of modulated data signal such as carrier waves.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for multi-dimensional visualization of data performed in a data display apparatus, the method comprising:
collecting data obtained by scanning at least one part of a sample, from at least one sensor;
comparing a resolution of 3-dimensional light emitting apparatus and a resolution of the scanned data;
adjusting the resolution of the scanned data to be matched with the resolution of the 3-dimensional light emitting apparatus, when the resolution of 3-dimensional light emitting apparatus is not identical to the resolution of the scanned data; and
displaying the data corresponding to the sample in the adjusted resolution by driving the 3-dimensional light emitting apparatus.

2. The method of claim 1, wherein the sensor comprises at least one of a pressure sensor, temperature sensor, friction sensor, photo sensor, magnetic sensor, acceleration sensor, angular velocity sensor, revolution sensor, infrared sensor, ultrasonic sensor, humidity sensor, touch sensor, gradient sensor, load sensor, vibration sensor, gravity sensor, gas sensor, proximity sensor, displacement sensor, hall sensor and piezoelectric sensor.

3. The method of claim 1, wherein the sensor comprises a camera.

4. The method of claim 1, wherein the scanned data are 1-dimensional arrangement data; and
the 1-dimensional arrangement data are combined with a reversed pattern of the sample that is scanned so that the 1-dimensional arrangement data are converted into 2-dimensional arrangement data.

5. The method of claim 1, wherein the scanned data are 2-dimensional arrangement data;
the 2-dimensional arrangement data are projected on a part basis to extract overlapped areas and are converted into 3-dimensional arrangement data based on the extracted area.

6. The method of claim 1, wherein the scanned data are data obtained by sampling on a part basis.

7. The method of claim 1, wherein the 3-dimensional light emitting apparatus comprises at least one light emitting device formed in 3-dimension; and
the at least one light emitting device is arranged in array.

8. The method of claim 1, wherein the 3-dimensional light emitting apparatus comprises at least one light emitting device formed in 3-dimension; and
the scanned data are displayed in the 3-dimensional light emitting apparatus based on at least one of position, light-on, light-off, color, brightness, and light-on/off period of the at least one light emitting device.

9. The method of claim 1, wherein the 3-dimensional light emitting apparatus comprises at least one light emitting device formed in 3-dimension; and
the at least one light emitting device is arranged in a cube shape.

10. The method of claim 1, wherein the scanned data are based on physical data for at least one part of the sample.

11. A data display apparatus comprising:
a collection unit configured to collect data obtained by scanning at least one part of a sample, from at least one sensor;
a comparison unit configured to compare a resolution of 3-dimensional light emitting apparatus and a resolution of the scanned data;
an adjustment unit configured to adjust the resolution of the scanned data to be matched with the resolution of the 3-dimensional light emitting apparatus, when the resolution of 3-dimensional light emitting apparatus is not identical to the resolution of the scanned data; and
an output unit configured to display the data corresponding to the sample in the adjusted resolution by driving the 3-dimensional light emitting apparatus.

12. The apparatus of claim 11, wherein the scanned data is 1-dimensional arrangement data; and
the collection unit is configured to combine the 1-dimensional arrangement data with a reversed pattern of the sample that is scanned so that the 1-dimensional arrangement data are converted into 2-dimensional arrangement data.

13. The apparatus of claim 11, wherein the scanned data is 2-dimensional arrangement data;
the collection unit is configured to project the 2-dimensional arrangement data for a part to extract overlapped areas and convert it into 3-dimensional arrangement data based on the extracted area.
